(19) United States
(12) Patent Application Publication
(10) Pub. No.: US 2015/0236544 A1
(43) Pub. Date: Aug. 20, 2015

(54) WIRELESS POWER FEEDING UNIT, ELECTRONIC APPARATUS, AND METHOD OF CONTROLLING WIRELESS POWER FEEDING UNIT

(71) Applicants: Masaya Uchida, Hyogo (JP); Junji Nishida, Osaka (JP); Atsushi Nishii, Hyogo (JP)

(72) Inventors: Masaya Uchida, Hyogo (JP); Junji Nishida, Osaka (JP); Atsushi Nishii, Hyogo (JP)

(73) Assignee: RICOH COMPANY, LTD., Tokyo (JP)

(21) Appl. No.: 14/426,812

(22) PCT Filed: Sep. 3, 2013
(86) PCT No.: PCT/JP2013/074169

§ 371 Date: Mar. 9, 2015

(30) Foreign Application Priority Data
Sep. 12, 2012 (JP) 2012-200259

(51) Int. Cl. H02J 7/02

(52) U.S. Cl. CPC H02J 7/025

(57) ABSTRACT

A wireless power feeding unit includes a receiving antenna; a control circuit having a wireless communication function in accordance with a communication standard; an impedance matching circuit, connected between the receiving antenna and the control circuit, for impedance matching between the receiving antenna and the control circuit; a conversion circuit converting alternate-current power into a direct-current voltage; a resonant circuit connected between the receiving antenna and the conversion circuit, receiving, in a resonant condition, electromagnetic energy via the receiving antenna, and outputting alternate-current power; and a switch circuit, based on a control signal from the control circuit, connecting the receiving antenna with the impedance matching circuit or the resonant circuit selectively. The control circuit controls the switch circuit so as to connect the receiving antenna with the impedance matching circuit for wireless communication and connect the receiving antenna with the resonant circuit for wireless power feeding.

### TECHNICAL FIELD

The present invention relates to a wireless power feeding unit having both functions of wireless communication and wireless power feeding, an electronic apparatus using the same, and a method of controlling the wireless power feeding unit.

### BACKGROUND ART

Currently, portable terminals that are in accordance with predetermined communication standards and carry out wireless communication with external apparatuses, using the principle of electromagnetic induction, and portable radios that are in accordance with communication standards of a plurality of frequency bands and carry out wireless communication, have been developed.

For example, as the portable terminals which carry out magnetic field communication using electromagnetic induction, one is known in which communication quality is improved by switching the number of turns of a coil depending on a strength of a carrier wave (see Japanese Laid-Open Patent Application No. 2011-097307). Further, as the portable radios which are in accordance with communication standards of a plurality of frequency bands and carry out wireless communication, one is known in which, in a case where the portable radio is operated using different frequency bands, communication quality of a frequency band to be used is improved by connecting a parallel resonant circuit to an impedance matching circuit (see Japanese Patent No. 3747010).

However, in the potable terminal according to Japanese Laid-Open Patent Application No. 2011-097307, it is necessary to provide a switch for switching the number of turns of a coil in an antenna element part. In this configuration, the number of switch connections increases as the numbers of turns of the coil in the antenna element part increase. As a result, the serial resistance of the antenna element part increases accordingly. As the serial resistance of the switch increases in addition to an increase in the inductance value of the antenna element part, it may be difficult to set optimum impedance matching circuit constants. Further, power is supplied to a communication control part from a receiving antenna, and a rectenna circuit and the impedance marching circuit connected with the receiving antenna are connected in parallel. In this configuration, due to the power supply to the communication control part and an influence of the rectenna circuit, it may be difficult to optimize the impedance matching circuit, and the data communication quality may be adversely affected.

According to the portable radio of Japanese Patent No. 3747010, it is necessary to receive information for designating a reception frequency, and also, it is necessary to prepare impedance matching circuits for the respective frequency bands in a case of using the plurality of frequency bands.

### SUMMARY OF INVENTION

According to one embodiment of the present invention, a wireless power feeding unit includes a receiving antenna; a control circuit that has a wireless communication function which is in accordance with a predetermined communication standard; an impedance matching circuit that is connected between the receiving antenna and the control circuit, and carries out impedance matching between the receiving antenna and the control circuit; a conversion circuit that converts alternate-current power into a direct-current voltage; a resonant circuit connected between the receiving antenna and the conversion circuit, the resonant circuit receiving, in a resonant condition, electromagnetic energy received by the receiving antenna, and outputting alternate-current power; and a switch circuit that, based on a control signal from the control circuit, connects the receiving antenna with the impedance matching circuit or the resonant circuit selectively. The control circuit controls the switch circuit so as to cause the switch circuit to connect the receiving antenna with the impedance matching circuit at a time of carrying out wireless communication and connect the receiving antenna with the resonant circuit at a time of carrying out wireless power feeding.

Other objects, features and advantages of the present invention will become more apparent from the following detailed description when read in conjunction with the accompanying drawings.

### BRIEF DESCRIPTION OF THE DRAWINGS

FIG. 1 is a block diagram showing a configuration of an electronic apparatus including a wireless power feeding unit according to a first embodiment;

FIG. 2 is a circuit diagram showing a configuration of a switch circuit shown in FIG. 1;

FIG. 3 is a block diagram showing a configuration of an electronic apparatus including a wireless power feeding unit according to a second embodiment;

FIG. 4 is a circuit diagram showing a configuration of a switch circuit shown in FIG. 3; and

FIG. 5 is a circuit diagram showing a configuration of a receiving antenna shown in FIG. 3.

### DESCRIPTION OF THE EMBODIMENTS

Below, the embodiments of the present invention will be described using the drawings. It is noted that for the respective embodiments, the same reference numerals are given to the same or corresponding parts/components.

### First Embodiment

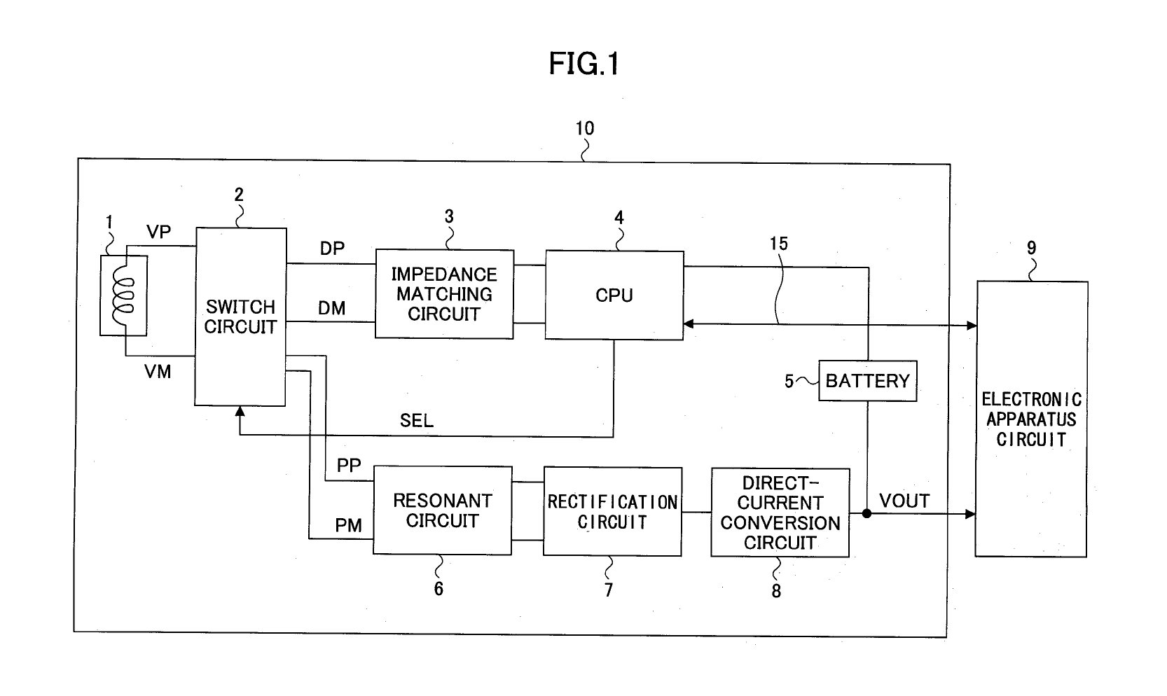

FIG. 1 is a block diagram showing a configuration of an electronic apparatus including a wireless power feeding unit 10 that has a wireless communication control function, according to a first embodiment. As shown in FIG. 1, the wireless power feeding unit 10 includes a receiving antenna 1, a switch circuit 2, an impedance matching circuit 3, a Central Processing Unit (CPU) 4 that is one example of a control circuit, a battery 5, a resonant circuit 6, a rectification circuit 7 and a direct-current conversion circuit 8.

The battery 5 supplies a predetermined direct-current voltage to the CPU 4, and also, supplies a predetermined direct-current voltage as a voltage VOUT to an electronic apparatus circuit 9 of the electronic apparatus such as a portable phone or a portable radio, for example.

Further, a predetermined communication interface 15 is provided for connecting the CPU 4 and the electronic apparatus circuit 9 for the purpose of carrying out data communication and communication of a control signal(s) therefor therebetween.

For the purpose of carrying out short-range wireless communication such as Near Field Communication (NFC) with an other wireless power feeding unit having a configuration the same as or similar to the wireless power feeding unit 10, the CPU 4 has a short-range wireless communication function in accordance with a predetermined communication standard. The CPU 4 is connected with the receiving antenna 1 via the impedance matching circuit 3 and the switch circuit 2. The impedance matching circuit 3 carries out impedance matching between the CPU 4 and the receiving antenna 1.

Further, in order to receive wireless power feeding from a power-supply unit that carries out wireless power feeding in accordance with a wireless power feeding system such as “Qi” (registered trademark), the receiving antenna 1 is connected with the rectification circuit 7 via the switch circuit 2 and the resonant circuit 6. The resonant circuit 6 is prepared for receiving, with low loss in a resonant condition, electromagnetic energy that the receiving antenna 1 receives.

The rectification circuit 7 rectifies the received alternate-current power and outputs the rectified power to the direct-current conversion part 8. The direct-current conversion part 8 converts the voltage rectified by the rectification circuit 7 into the predetermined voltage VOUT and supplies the voltage VOUT to the battery 5 and the electronic apparatus circuit 9.

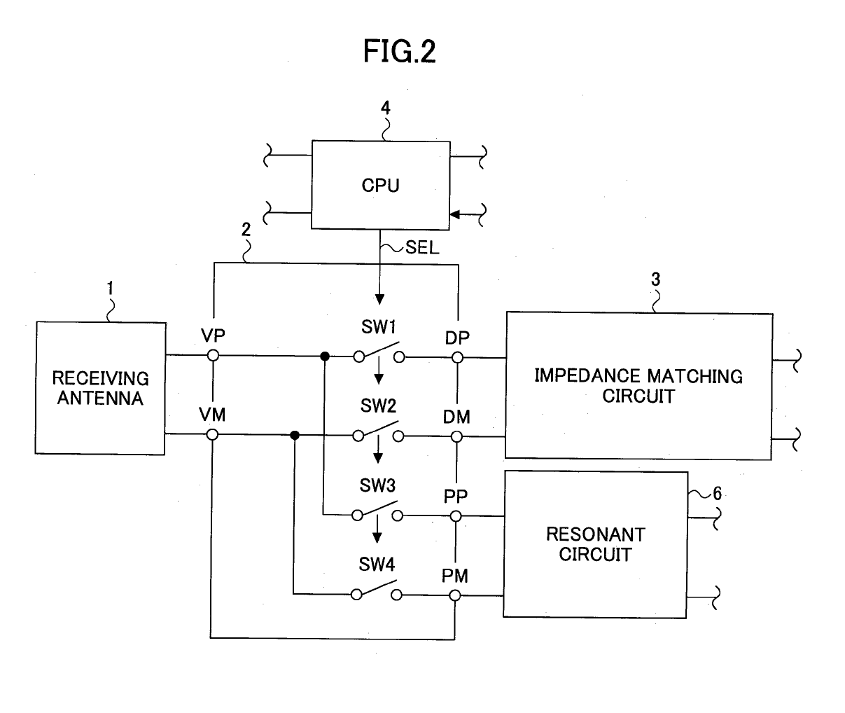

FIG. 2 is a circuit diagram showing the configuration of the switch circuit 2 shown in FIG. 1. Using FIGS. 1 and 2, operations of the wireless power feeding unit 10 having the wireless communication control function will be described.

At a time of carrying out data communication in accordance with the short-range wireless communication, the CPU 4 outputs a change-over signal (referred to as a SEL signal hereinafter) for data communication control to the switch circuit 2 which responds to the SEL signal and connects the output terminals VP and VM of the receiving antenna 1 to the input terminals DP and DM of the impedance matching circuit 3, respectively. At this time, in the switch circuit 2, switches SW1 and SW2 are turned on, and switches SW3 and SW4 are turned off.

The CPU 4 generates a wireless signal in accordance with the short-range wireless communication system such as NFC, and transmits the wireless signal from the receiving antenna 1 via the impedance matching circuit 3 and the switch circuit 2 to the other wireless power feeding unit. Also, the CPU 4 receives a wireless signal in accordance with the short-range wireless communication system from the other wireless power feeding unit using the receiving antenna 1 via the switch circuit 2 and the impedance matching circuit 3.

On the other hand, at a time of not carrying out data communication, the CPU outputs an other SEL signal for wireless power feeding control to the switch circuit 2 which responds to the other SEL signal and connects the output terminals VP and VM of the receiving antenna 1 to the input terminals PP and PM of the resonant circuit 6, respectively. At this time, in the switch circuit 2, switches SW1 and SW2 are turned off, and switches SW3 and SW4 are turned on.

The receiving antenna 1 receives wireless power feeding from the power-supply unit that carries out wireless power feeding in accordance with the wireless power feeding system such as “Qi” (registered trademark), and outputs the received power to the rectification circuit 7 via the resonant circuit 6. The resonant circuit 6 receives, with low loss (in a manner of maximum electric power transmission), electromagnetic energy that the receiving antenna 1 has received, and outputs alternate-current power. The rectification circuit 7 rectifies the received alternate-current power and outputs the rectified power to the direct-current conversion circuit 8. The direct-current conversion circuit 8 converts the rectified voltage into the predetermined direct-current voltage VOUT, and supplies the voltage VOUT to the battery 5 and the electronic apparatus circuit 9.

It is to be noted that, for example, the CPU 4 receives, from the electronic apparatus circuit 9 via the communication interface 15, a control signal giving an instruction designating whether to carry out data communication control or wireless power feeding control. Then, in response to the control signal, the CPU 4 determines whether to connect the receiving antenna 11 with the impedance matching circuit 3 or the resonant circuit 6, and outputs the corresponding SEL signal to the switch circuit 2.

In the first embodiment described above, at a time of carrying out data communication, the circuit parameter(s) of the impedance matching circuit 3 is(are) set in such a manner that the quality factor (Q) is maximized, for example, at the carrier frequency of data communication in accordance with the short-range wireless communication such as NFC, as in a general way, in order to obtain good communication sensitivity.

On the other hand, at a time of carrying out wireless power feeding control, the parameter(s) of the resonant circuit 6 is (are) set to a predetermined value(s) in consideration of operations of the rectification circuit 7 and/or the direct-current conversion circuit 8 which carry out wireless power feeding in accordance with the wireless power feeding system such as Qi (registered trademark), for example.

As described above, according to the first embodiment, the switch circuit 2 is provided at the output terminals of the receiving antenna 1, and therewith, the connection of the receiving antenna at a time of carrying out data communication and the connection of the receiving antenna 1 at a time of carrying out wireless power feeding (i.e., not carrying out data communication) are made different from one another. As a result, it is possible to prevent the circuit configuration at a time of carrying out data communication and the circuit configuration at a time of carrying out wireless power feeding (i.e., not carrying out data communication) from being influenced from one another. Therefore, it is possible to optimize the impedance matching at each of both times of carrying out data communication and carrying out wireless power feeding (i.e., not carrying out data communication). Thus, it is possible to realize the wireless power feeding unit 10 having the wireless power feeding function without degradation of the wireless communication quality.

### Second Embodiment

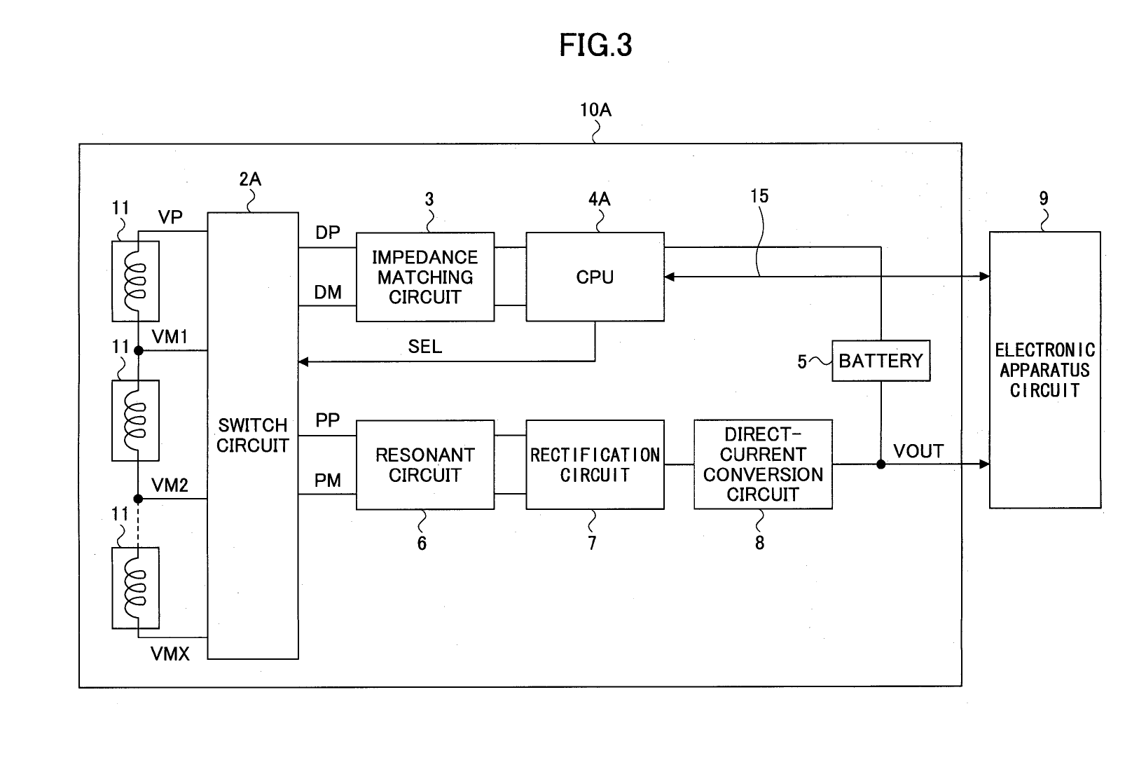

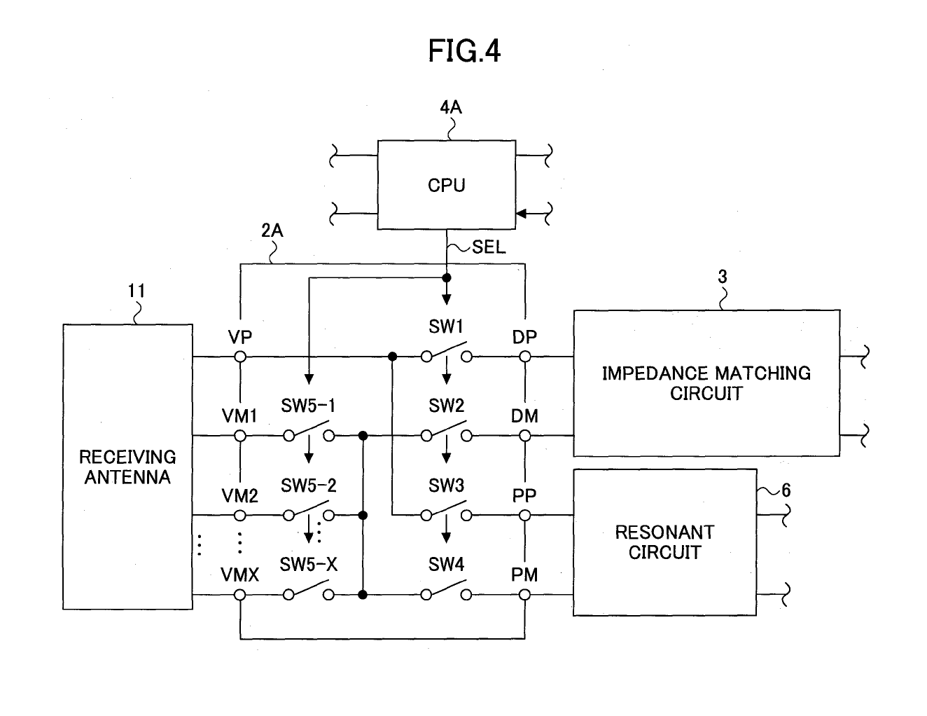

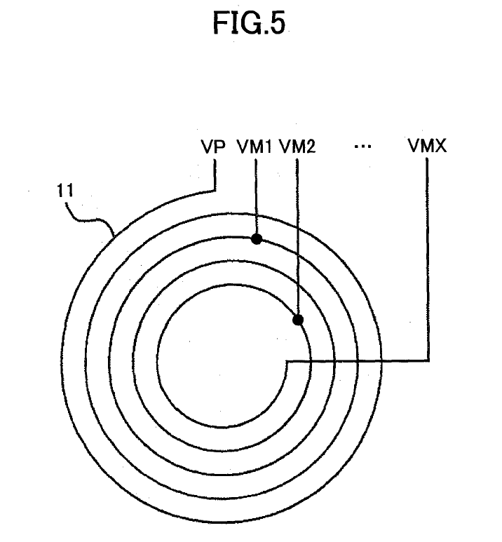

FIG. 3 is a block diagram showing a configuration of an electronic apparatus including a wireless power feeding unit 10A according to a second embodiment. FIG. 4 is a circuit diagram showing a configuration of a switch circuit 2A shown in FIG. 3. FIG. 5 is a circuit diagram showing a configuration of a receiving antenna 11 shown in FIG. 3. The wireless power feeding unit 10A according to the second embodiment is different from the wireless power feeding unit 10 according to the first embodiment described above in the following points.

(1) Instead of the receiving antenna 1, the receiving antenna 11 is provided which has a plurality of turns of winding, and has X−1 intermediate taps VM1, VM2, . . . , VM(X−1) between output terminals VP and VMX.

As shown in FIGS. 3, 4 and 5, the X−1 intermediate taps VM1, VM2, . . . , VM(X−1) are provided for a respective number of turns of the plurality of turns of winding, in which the number of turns have been previously set. The number of turns of the plurality of turns of winding in the receiving antenna 11 to be used for the short-range wireless communication, for example, NFC, are set to vary according to each of the respective communication frequency bands of the plurality of short-range wireless communication systems.

(2) Instead of the switch circuit 2, the switch circuit 2A is provided for selectively connecting the receiving antenna 11 with the impedance matching circuit 3 or the resonant circuit 6. At this time, more specifically, as shown in FIG. 4, the switch circuit 2A selectively connects the output terminal VP of the receiving antenna 11 with the input terminal DP of the impedance matching circuit 3 or the input terminal PP of the resonant circuit 6, and also, selectively connects any one of the intermediate taps VM1, VM2, . . . , VM(X−1) and the output terminal VMX of the receiving antenna 11 with the input terminal DM of the impedance matching circuit 3 or the input terminal PM of the resonant circuit 6.

(3) Instead of the CPU 4, a CPU 4A is provided which is in accordance with the plurality of short-range wireless communication systems and controls the switch circuit 2A.

At a time of starting operations of data communication, the CPU 4A in accordance with the standards of the plurality of short-range wireless communication systems outputs a corresponding SEL signal for one of the communication standards of the respective short-range wireless communication systems to be used to the switch circuit 2A. Thus, the CPU 4A controls the switch circuit 2A in such a manner that the receiving antenna 11 has the number of turns of the plurality of turns of winding corresponding to the carrier frequency of the communication standard of the short-range wireless communication system to be used to operate. Thereby, the inductance value that is most suitable for the corresponding one of the frequency bands that are previously set for the respective communication standards is obtained. Thus, it is possible to adjust the characteristics concerning the quality factor (Q) of the circuit including the impedance matching circuit 3

In the switch circuit 2A of FIG. 4, the switching control concerning the switches SW1, SW2, SW3 and SW4 is the same as that of the first embodiment described above. As to X switches SW5-1, SW5-2, . . . , and SW5-X, any one of the X switches SW5-1, SW5-2, . . . , and SW5-X is turned on according to one of the frequency bands corresponding to the respective communication standards based on the SEL signal from the CPU 4A. Thereby, the inductance value of the receiving antenna 11 is switched for each of the communication bands to be actually used.

It is to be noted that, for example, the CPU 4A receives, from the electronic apparatus circuit 9 via the communication interface 15, a control signal(s) giving instructions designating whether to carry out data communication control or wireless power feeding control, and also, which of the plurality of communication standards is to be actually used at the time of carrying out the data communication control. Then, in response to the control signal, the CPU 4A determines whether to connect the receiving antenna 11 with the impedance matching circuit 3 or the resonant circuit 6, and also, which of the X switches SW5-1, SW5-2, . . . , and SW5-X is to be turned on, and then, outputs the corresponding SEL signal to the switch circuit 2A.

As described above, according to the second embodiment, the switch circuit 2A is provided at the output terminals (VP and VMX) and the intermediate taps (VM1, VM2, . . . , VM(X−1)) of the receiving antenna 11. As a result, the connection of the receiving antenna 11 at a time of carrying out data communication and the connection of the receiving antenna 11 at a time of carrying out wireless power feeding (i.e., not carrying out data communication) are made different therebetween. As a result, it is possible to prevent the circuit configuration at a time of carrying out data communication and the circuit configuration at a time of carrying out wireless power feeding (i.e., not carrying out data communication) from being influenced from one another. Thus, it is possible to optimize impedance matching at each of both times of carrying out data communication and carrying out wireless power feeding (i.e., not carrying out data communication). Further, according to the second embodiment, it is possible to change the number of turns of the plurality of turns of winding of the receiving antenna 11 depending on the communication standard of the short-range wireless communication system to be used, it is possible to obtain the impedance value most suitable for the corresponding one of the frequency bands that are previously set for the respective communication standards, and thus, it is possible to adjust the characteristics concerning the quality factor (Q) of the circuit including the impedance matching circuit 3. Therefore, it is possible to realize the wireless power feeding unit having the wireless power feeding function without degradation of the wireless communication quality.

According to the wireless power feeding units, the electronic apparatuses having the same, and the methods of controlling the wireless power feeding units in the embodiments, each of the wireless power feeding units having the wireless communication function and the wireless power feeding function, and carrying out wireless communication and wireless power feeding in a manner of switching the function to be actually used, it is possible to realize the wireless communication control function by which it is possible to optimize the power efficiency at a time of wireless power feeding without degradation in the communication quality at a time of wireless communication.

Although the wireless power feeding units, the electronic apparatuses having the same, and the methods of controlling the wireless power feeding units have been described by the embodiments, the present invention is not limited to the specifically disclosed embodiments, and variations and modifications may be made without departing from the scope of the present invention.

For example, in the above-described second embodiment, the number of turns of the plurality of turns of winding in the receiving antenna 11 to be used in the short-range wireless communication is set to vary depending on one of the communication bands or carrier frequencies of the plurality of short-range wireless communication systems to be actually used to operate. However, embodiments of the present invention are not limited thereto, and it is also possible that, using the above-mentioned intermediate taps, the length of the receiving antenna 11 is set to vary depending on one of the communication bands or carrier frequencies of the plurality of short-range wireless communication systems to be actually used to operate.

The present application is based on and claims the benefit of priority of Japanese Priority Application No. 2012-200259 filed on Sep. 12, 2012, the entire contents of which are hereby incorporated herein by reference.

1. A wireless power feeding unit comprising:
a receiving antenna;
a control circuit that has a wireless communication function which is in accordance with a predetermined communication standard;
an impedance matching circuit that is connected between the receiving antenna and the control circuit, and carries out impedance matching between the receiving antenna and the control circuit;
a conversion circuit that converts alternate-current power into a direct-current voltage;
a resonant circuit connected between the receiving antenna and the conversion circuit, the resonant circuit receiving, in a resonant condition, electromagnetic energy received by the receiving antenna, and outputting alternate-current power; and
a switch circuit that, based on a control signal from the control circuit, connects the receiving antenna with the impedance matching circuit or the resonant circuit selectively,
wherein the control circuit controls the switch circuit so as to cause the switch circuit to connect the receiving antenna with the impedance matching circuit at a time of carrying out wireless communication and connect the receiving antenna with the resonant circuit at a time of carrying out wireless power feeding.

2. The wireless power feeding unit as claimed in claim 1, wherein
the control circuit has wireless communication functions that are in accordance with a predetermined plurality of communication standards,
the receiving antenna has a length that is variable among a plurality of lengths in accordance with carrier frequencies of the plurality of communication standards,
when the switch circuit connects the receiving antenna with the impedance matching circuit, the switch circuit connects the receiving antenna having one of the plurality of lengths with the impedance matching circuit, and
the control circuit controls the switch circuit so as to cause the switch circuit to connect, at the time of carrying out wireless communication, the impedance matching circuit and the receiving antenna having one of the plurality of lengths corresponding to the carrier frequency of the communication standard that is set.

3. The wireless power feeding unit as claimed in claim 2, wherein
the receiving antenna is wound a plurality of turns and has a plurality of intermediate taps, the receiving antenna having the length variable among the plurality of lengths corresponding to the carrier frequencies of the plurality of communication standards and corresponding to a number of turns of the plurality of turns of the receiving antenna,
when the switch circuit connects the receiving antenna with the impedance matching circuit, the switch circuit connects the receiving antenna having the number of turns with the impedance matching circuit, and
the control circuit controls the switch circuit so as to cause the switch circuit to connect, at the time of carrying out wireless communication, the impedance matching circuit and the receiving antenna having the number of turns corresponding to the carrier frequency of the communication standard that is set.

4. An electronic apparatus comprising:
the wireless power feeding unit claimed in claim 1; and
an electronic apparatus circuit, to which the conversion circuit of the wireless power feeding unit supplies the direct-current voltage, the electronic apparatus circuit being connected with the control circuit of the wireless power feeding unit via a predetermined communication interface.

5. A method of controlling a wireless power feeding unit, the method comprising
controlling, by one or more processors, a switch circuit so as to cause the switch circuit to connect a receiving antenna with an impedance matching circuit at a time of carrying out wireless communication and connect the receiving antenna with a resonant circuit at a time of carrying out wireless power feeding, wherein
the wireless power feeding unit includes,
the receiving antenna,
the impedance matching circuit that carries out impedance matching,
the resonant circuit that receives, in a resonant condition, electromagnetic energy received by the receiving antenna, and outputs alternate-current power, and
the switch circuit that connects the receiving antenna with the impedance matching circuit or the resonant circuit selectively.

6. The method as claimed in claim 5, wherein
the controlling includes controlling, by the one or more processors, the switch circuit so as to cause the switch circuit to connect, at the time of carrying out wireless communication, the impedance matching circuit and the receiving antenna having one of a plurality of lengths corresponding to a carrier frequency of a communication standard that is set, wherein
the receiving antenna has a length that is variable among the plurality of lengths in accordance with carrier frequencies of a plurality of communication standards, and
when the switch circuit is controlled by the one or more processors to connect the receiving antenna with the impedance matching circuit, the switch circuit is controlled by the one or more processors to connect the receiving antenna having one of the plurality of lengths with the impedance matching circuit.

7. The method as claimed in claim 6, wherein
the controlling includes controlling, by the one or more processors, the switch circuit so as to cause the switch circuit to connect, at the time of carrying out wireless communication, the impedance matching circuit and the receiving antenna having a number of turns corresponding to the carrier frequency of the communication standard that is set, wherein
the receiving antenna is wound a plurality of turns and has a plurality of intermediate taps, the receiving antenna having the length variable among the plurality of lengths corresponding to the carrier frequencies of the plurality of communication standards and corresponding to the number of turns of the plurality of turns of the receiving antenna, and
when the switch circuit is controlled by the one or more processors to connect the receiving antenna with the impedance matching circuit, the switch circuit is controlled by the one or more processors to connect the receiving antenna having the number of turns with the impedance matching circuit.
